(19) United States
(12) Patent Application Publication
(10) Pub. No.: US 2007/0180044 A1
(43) Pub. Date: Aug. 2, 2007

(54) Operating device

(75) Inventors: Rodolfo Mann Pelz, Hannover (DE); Thomas May, Wolfenbuettel (DE); Ralf Flemme, Hannover (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 10/558,075

(22) PCT Filed: May 4, 2004
(86) PCT No.: PCT/EP04/50691

§ 371 Date: Jan. 3, 2007

(30) Foreign Application Priority Data
May 23, 2003 (DE) 103 23 466.7

(51) Int. Cl. G06F 15/16

(52) U.S. Cl. 709/208

(57) ABSTRACT

An operating device for controlling several electronic devices is provided, in which an operator interface of an electronic device to be controlled is transmitted to the operating device.

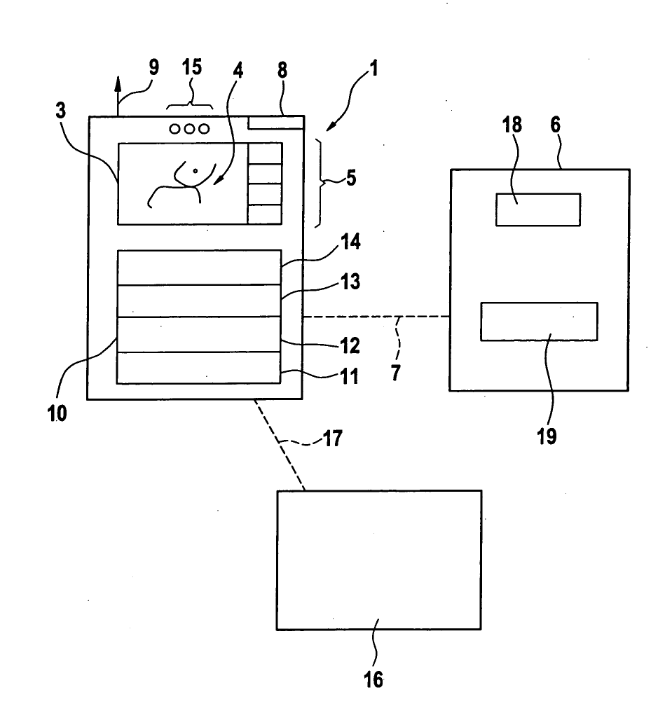

### FIELD OF THE INVENTION

The present invention relates to an operating device.

### BACKGROUND INFORMATION

With increasing complexity, electronic devices also require more intricately designed operator interfaces. Particularly in motor vehicles, numerous devices are installed such as e.g. a navigation device, a radio, music playback devices or other communications devices which likewise offer a multitude of functions and require corresponding controls. Such a control is generally implemented via suitable screen representations, which however require large displays having a relatively high resolution and which are therefore expensive. Portable small computers (so-called handhelds or PDAs (Personal Digital Assistant)) are already relatively inexpensive and offer good computing power. German Published Patent Application No. 199 35 893 describes a motor vehicle having a vehicle electronics, in which a PC interface of the vehicle electronics makes it possible to control functions of the vehicle electronics via a handheld computer in addition to the computer functions themselves and to obtain a screen output via the display of the handheld computer. For this purpose, it is necessary that the vehicle electronics continuously transmits the respective image output data to the handheld computer and that the actual computation of these image data occurs in the vehicle electronics.

### SUMMARY OF THE INVENTION

By contrast, the operating device according to the present invention has the advantage that data of an operator interface of an electronic device are transmitted via a data interface to an operating device such that this operator interface is now available in the operating device, that it can be processed there and that it can be used to control the electronic device. Without further access to the electronic device or to another data source, it is thus possible to provide certain control functionalities in the operating device. The operating device can thus be used for comfortably controlling a multitude of electronic devices, merely one operating device being required for controlling the multitude of devices. By transmitting the program data of the user interface to the operating device, these can be executed on the operating device itself such that the computing power of the operating device is utilized. In particular it is thus possible in a simple manner to improve or simplify the operation of an electronic device by updating the software of the operator interface without having to make changes to the electronic device itself. Thus it would be possible, for example, to install a voice control on the operating device, which allows for the electronic device to be controlled by voice without the electronic device itself being designed for a voice control.

It is particularly advantageous to design the data interface as an air interface such that no cable connection between the operating device and the electronic device is required for operating the electronic device.

It is further advantageous to transmit the operator interface from the electronic device to the operating device. In particular, this allows for the operating device to be connected to the electronic device if required in order to load a corresponding operator interface when a user wants to operate the respective electronic device.

Furthermore it is advantageous to transmit the operator interface from another processing unit to the operating device since an updated operator interface can thereby be provided, which e.g. is not present in the electronic device itself.

It is further advantageous to write the operator interface in an HTML (Hypertext Markup Language), XML (Extensible Markup Language) or XUL (XML-based User Interface Language) data format since these data formats are defined by the W3C (World Wide Web Consortium) and are standardly available. This facilitates exchanging the user interface, to extend it and to adapt it to a particular electronic device since universally available standardized data formats are used.

Furthermore it is advantageous to set up the operator interface on a first operating system (middleware) having an interface to the operator interface that is likewise standardized and hardware-independent. By this means it is possible to use the user interface on operating devices implemented in different hardware. The first operating system (middleware) on the other hand is adapted to the available hardware. It is particularly advantageous to design the first operating system as an OSGi (Open Service Gateway initiative) operating system, which in particular allows for an extension of the user interface to be performed even during the execution time, i.e. during the processing of program data, and to be able to use the security measures provided by OSGi and the programming language Java, on which the operating system OSGi is based. In this instance, an advantageous integration of a new user interface occurs in such a way that the user interface is loaded into the operating device, where it is first registered and subsequently executed in the operating device itself. This ensures an integration of the operator interface into the program data structure of the operating device.

It is further advantageous to implement the operating device as a portable handheld device, which allows for a mobility such that the operating device can be transferred to different electronic devices to be controlled.

### BRIEF DESCRIPTION OF THE DRAWING

The FIGURE shows an operating device according to the present invention in combination with an electronic device and in the optional combination with another processing unit.

### DETAILED DESCRIPTION

The present invention may be used for a multitude of electronic devices. The following describes the present invention with reference to the example of a control of a navigational device in a motor vehicle. Apart from the navigational device, additional electronic devices, particularly communications devices and media playback devices may be used in the motor vehicle. For particularly in a vehicle there is the problem that for representing vehicle functions and for controlling multimedia applications only a limited space is available for the control, the vehicle functions taking precedence. Using the operating device of the present invention it is possible to provide in each case a convenient operator interface particularly for the different multimedia devices in the motor vehicle.

An operating device 1 is represented in the FIGURE. Operating device 1 has a housing, which is equipped with an autonomous power supply e.g. in the form of a battery or an accumulator. A processing unit not shown in the FIGURE controls a display 3, which preferably takes the form of a touch-sensitive display. In the present exemplary embodiment, a map illustration 4 is shown on display 3, next to which menu fields 5 forming a graphical operator interface are visible on display 3. Via menu fields 5 it is possible to control a navigational device 6, which is permanently installed in a motor vehicle. In a preferred specific embodiment, operating device 1 is connected to navigational device 6 via an interface in the form of a wireless connection 7. In a further specific embodiment (not shown), wireless connection 7, however, may also be replaced by a cable. Wireless connection 7 is e.g. represented by an infrared interface or a radio interface. The radio interface, for example, may take the form of a bluetooth interface. For establishing an infrared connection, a suitable infrared transmitting unit 8 is optionally provided on the housing of operating device 1. If required, an antenna 9 may also be situated on operating device 1. In addition to a radio connection or in place of a radio connection to navigational device 6, antenna 9 may also be used to establish a mobile telephone connection to a cellular telephone network.

The program data of operating device 1 are stored in a memory 10 of operating device 1. Driver data of operating device 1 are stored in a first memory area 11. The driver data are used to control basic functions of operating device 1. Thus the driver data are used, for example, to drive display 3 or wireless connection 7 to navigational device 6. A basic operating system of operating device 1 is stored in a second memory area, which controls the hardware of operating device 1 and ensures the communication between individual components of operating device 1 by taking into account the driver data stored in first memory area 11. Thus the basic operating system in second memory area 12 also controls the function of a processing unit, not shown in the FIGURE, which is integrated into operating device 1. In a third memory area 13, an application operating system is set up on the basic operating system, the application operating system representing an interface to the program data of an operator interface represented in display 3. The application operating system allows for an execution of the program data that are required for the display and for the operation of the operator interface. For this purpose, the execution of the program data may occur independently of the hardware and of the drivers of operating device 1. For the program data work together only with the application operating system. The program data of the operator interface themselves are stored in a fourth memory area 14.

If a user wants to control an electronic device using operating device 1, the user loads the corresponding data of an operator interface of the electronic device into fourth memory area 14. Depending on the size of memory 10, there may be room in each instance for one electronic device to be controlled. The size of memory 10 permitting, however, the data of several devices to be controlled may be stored in fourth memory area 14 of operating device 1. The data of the operator interface may on the one hand comprise the graphical appearance of the display. In addition, however, other function data and instruction data may be stored as well.

Thus, for example, code data representing certain instructions of the electronic device may be stored. If a user how selects a certain function, then the corresponding code data are transmitted to the electronic device, which interprets this code and then executes the corresponding instruction. Preferably, the data of the operator interface also comprise a menu structure of primary menu items and respectively associated subsidiary menus. The subsidiary menus may be accessed by respectively selecting primary menu items. Optionally it is also possible that the instructions provided with the operator interface first enable certain functions of the electronic device itself, which are not accessible or available by the electronic device alone. Functions in the electronic device may either be activated by operating device 1 or functions may be enabled in cooperation between the electronic device and operating device 1, for example a voice control of the electronic device. This makes it possible to offer operator interfaces for an electronic device that have different functional scopes and which could accordingly also be distributed at different prices.

In a first specific embodiment, the data of the operator interface are transmitted from the electronic device, in this case navigational device 6, to operating device 1. Navigational device 6 has a memory 18, in which the data of the operator interface are stored. A wired connection between navigational device 6 and operating device 1 takes the form of an RS232 interface, for example, but may also be replaced by a radio connection.

In a further specific embodiment it is also possible for the data of the operator interface to be transmitted from another processing unit 16 via a data connection 17, a radio connection or a cable connection, to operating device 1. In a first exemplary embodiment, additional processing unit 16 is implemented as a portable computer, for example, in the form of a laptop, which can access the data of the operator interface to be loaded either via a storage medium or via an Internet access. In another specific embodiment, data connection 17 is established via a telephone connection to additional processing unit 16, which takes the form of an external service center. The latter may be operated by the manufacturer of the electronic device, for example, such that regular updates of the operator interface of the electronic device may be provided.

Navigational device 6, which has additional functional components such as a locating unit or a road map storage, for example, that are not shown in the FIGURE, also has a program data memory 19 and possibly also a user interface, which allows for navigational device 6 to be operated in the event that a user has not brought operating device 1 along into the vehicle. An operation of navigational device 6 now occurs in such a way that a user selects menu items 5 listed on display 3. As a function of an actuation of such a menu item, operating device 1 causes the transmission of an instruction to navigational device 6 via interface 7. According to a correlation of the instruction on the part of a processing unit of navigational device 6 not shown in the FIGURE, an instruction is executed by processing associated program data of navigational device 6 stored in program data memory 19. Such an instruction, for example, is a calculation of a driving route from a starting point to a destination.

Alongside touch-sensitive display 3, additional operational controls may be situated on operating device 1, e.g. rotary wheels or push-buttons. In a preferred specific embodiment, operating device 1 has a microphone 15, which allows for a voice control. In a particularly advantageous manner, respective instructions of the voice control may be loaded as part of the user interface. Thus, the user interface is not necessarily purely visual, but may also include a voice control. Now if a user wants to operate another device, the user selects this device via operational controls of operating device 1. In the switch to the other electronic device, first the corresponding operator interface is loaded if it is not already stored in fourth memory area 14 of operating device 1. Particularly in the use for controlling a navigational device, a user gains the additional advantage that a map illustration 4 on display 3 of operating device 1 is available in high resolution, it being optionally possible to pass on operating device 1 to fellow passengers as well. Particularly for the application of a logbook function, logbook data regarding location and time may be transmitted directly to operating device 1 and thus conveniently taken along out of the vehicle.

In another specific embodiment, operating device 1 may also provide an operator interface respectively associated with an access control. Thus, for example, maintenance functions for testing and for error diagnosis may be provided solely for automotive workshops. It is possible, for example, to use operating device 1 in a connection to a car radio for checking received field strengths in a radio broadcast reception, particularly in the case of an investigation by a radio technician.

In another specific embodiment it is additionally possible to transmit function data from the electronic device to the operating device. In particular, the refinement having an OSGi operating system allows for a hardware-independent exchange of data in both directions between the operating device and the electronic device. Thus it is also possible for the operating device e.g. in combination with a navigational device to take over the planning of the route entirely and thus for it to be used outside of the vehicle as well.

1.-10. (canceled)

11. An operating device for controlling at least one electronic device, comprising:
a data interface; and
a display for representing an operator interface of the at least one electronic device to be controlled, wherein the operator interface of the at least one electronic device to be controlled is transmitted to the operating device via the data interface.

12. The operating device as recited in claim 11, wherein the data interface includes an air interface.

13. The operating device as recited in claim 11, wherein the operator interface is transmitted from the at least one electronic device to the operating device.

14. The operating device as recited in claim 11, wherein the operator interface is transmitted from an additional processing unit to the operating device.

15. The operating device as recited in claim 11, wherein the operator interface is written in one of HTML, XML, and XUL.

16. The operating device as recited in claim 11, further comprising:
an arrangement for implementing the operator interface on an application operating system for controlling a processing of the operator interface, wherein:
the application operating system interacts with a basic operating system on the operating device in such a way that the basic operating system allows for an operation of the application operating system.

17. The operating device as recited in claim 16, wherein the application operating system includes an OSGi (Open Service Gateway initiative) operating system.

18. The operating device as recited in claim 11, wherein:
a displayed operator interface of the operating device is extended in that a corresponding data packet of the operator interface is loaded into the operating device, is registered there, and is subsequently executed there.

19. The operating device as recited in claim 11, wherein the operating device includes a portable hand-held device.

20. The operating device as recited in claim 11, wherein the operating device is for controlling a navigational device in a motor vehicle.
